(19) United States
(12) Patent Application Publication
(10) Pub. No.: US 2013/0202882 A1
(43) Pub. Date: Aug. 8, 2013

(54) HIGHLY THERMALLY CONDUCTIVE RESIN MOLDED ARTICLE, AND MANUFACTURING METHOD FOR SAME

(71) Applicants: Soichi Uchida, Settsu-shi (JP); Kazuaki Matsumoto, Settsu-shi (JP); Masashi Sakaguchi, Settsu-shi (JP); Yasushi Noda, Settsu-shi (JP); Syoji Ubukata, Settsu-shi (JP)

(72) Inventors: Soichi Uchida, Settsu-shi (JP); Kazuaki Matsumoto, Settsu-shi (JP); Masashi Sakaguchi, Settsu-shi (JP); Yasushi Noda, Settsu-shi (JP); Syoji Ubukata, Settsu-shi (JP)

(73) Assignee: KANEKA CORPORATION, Osaka-shi, Osaka (JP)

(21) Appl. No.: 13/878,714

(22) PCT Filed: Oct. 11, 2011
(86) PCT No.: PCT/JP2011/073326

§ 371 Date: Apr. 10, 2013

(30) Foreign Application Priority Data
Oct. 13, 2010 (JP) 2010-230858

(51) Int. Cl. C08L 67/00; C08K 7/00

(52) U.S. Cl. CPC C08L 67/00; C08K 7/00
USPC 428/338; 264/108; 428/221

(57) ABSTRACT

The present invention provides a highly thermally conductive resin molded article that satisfies all demands of a high thermal conductivity, an insulation property, a low density, a mechanical strength, a high flowability of a thin-walled molded article, less abrasion on a die used for manufacturing, and high whiteness. The highly thermally conductive resin molded article at least includes (A) thermoplastic polyester resin, (B) platy talc particles, and (C) a fiber reinforcement, and (B) platy talc particle content falls within a range between 10% by volume and 60% by volume, where the entire composition is 100% by volume, a number average particle size of the platy talc particles falls within a range between 20 μm and 80 μm, and the (B) platy talc particles are oriented in a surface direction of the highly thermally conductive resin molded article.

### TECHNICAL FIELD

The present invention relates to a highly thermally conductive resin molded article and a method for manufacturing the highly thermally conductive resin molded article. Specifically, the present invention relates to (i) a highly thermally conductive resin molded article containing thermoplastic resin and (ii) a method for manufacturing the highly thermally conductive resin molded article.

### BACKGROUND ART

Conventionally, molded articles containing a thermoplastic resin composition have been applied to various uses such as (i) housings of devices such as personal computers and display devices, (ii) electronic device materials, (iii) interiors and exteriors of automobiles, (iv) members of lighting apparatuses, and (v) mobile electronic devices such mobile phones. In such a case, a problem can occur that generated heat is difficult to release, because thermoplastic resin such as plastic has thermal conductivity lower than that of an inorganic substance such as a metal material. In order to solve such a problem, an attempt has been generally carried out in which a highly thermally conductive resin composition is obtained by adding a large quantity of highly thermally conductive inorganic substances to the thermoplastic resin. The highly thermally conductive inorganic compound can be a highly thermally conductive inorganic substance such as graphite, carbon fiber, low melting metal, alumina, or aluminum nitride. The highly thermally conductive inorganic substance needs to be mixed in the resin usually by 30% by volume or more, preferably, by a high content, i.e., 50% by volume or more.

In a case where the graphite, the carbon fiber, the low melting metal, or the like is contained in the highly thermally conductive resin composition, it is possible to obtain a resin molded article that has a relatively high thermal conductivity. However, the resin molded article thus obtained has an electrical conductivity as well, and it is therefore difficult to differentiate such a resin molded article from metals in terms of electrical conductivity. Consequently, applications of such a resin molded article are limited. A highly thermally conductive resin in which the alumina is contained can have both an electric insulation property and a high thermal conductivity. However, a density of alumina is higher than resin, and accordingly a density of the obtained resin molded article becomes high. Therefore, the use of alumina (i) is difficult to meet a demand for reducing weight of products such as a mobile electronic device and members of a lighting apparatus and (ii) cannot make a large contribution to improvement in thermal conductivity. In a case where aluminum nitride is used, it is possible to obtain a resin composition that has a relatively high thermal conductivity, but a property such as hydrolyzability of aluminum nitride may cause a problem.

In a case of a highly thermally conductive resin composition in which a high content of filler made of a highly thermally conductive inorganic substance is introduced, injection moldability is significantly decreased because of the high content of the filler. This causes the following problem: in a case where such a highly thermally conductive resin composition is molded by the use of a die having a practical shape or by a die having a pin gate, it is extremely difficult to carry out injection molding. For example, Patent Literature 1 discloses a method for improving injection moldability of a highly thermally conductive resin composition, which is filled with a high content of filler, by adding a liquid organic compound at a room temperature.

However, the method disclosed in Patent Literature 1 has a problem such as contamination of a die caused by bleedout of the liquid organic compound in injection molding. Although other various methods for improving the injection moldability have been considered, no effective method has been found yet.

Formerly, members of a lighting apparatus, such as a light bulb socket and a luminous tube holder, have been mostly made of thermosetting resin. However, instead of the thermosetting resin, thermoplastic resin is becoming popular in consideration of factors such as processability and cost. In this case, the thermoplastic resin needs to have high light resistance (whiteness). For example, Patent Literature 2 discloses a white thermoplastic polyester resin composition that contains a large amount of white pigment containing titanium oxide so as to achieve the high light resistance (whiteness).

However, according to the method disclosed in Patent Literature 2, the large amount of white pigment is added, and it is therefore impossible to fully meet recent demands on the members of a lighting apparatus, that is, demands for reduction in size, long life, greater functionality such as high thermal conductivity.

Under the circumstances, a technique has been considered in recent years, in which a highly thermally conductive resin composition is obtained with the use of a filler other than graphite, carbon fiber, low melting metal, alumina, aluminum nitride, and titanium oxide.

For example, Patent Literature 3 discloses a highly thermally conductive resin composition containing polyarylene sulfide (polyphenylene sulfide) resin, talc, and flattened cross-sectioned glass fibers. Moreover, Patent Literatures 4 through 6 disclose respective highly thermally conductive resin compositions in which polystyrene (Patent Literature 4), polyamide (Patent Literature 5), and polyolefin (Patent Literature 6) are used as base material resin instead of the polyarylene sulfide resin of Patent Literature 3.

Patent Literature 7 discloses a highly thermally conductive resin composition in which talc, which has been subjected to an antalkaline treatment, and white pigment are mixed with a polycarbonate copolymer having a high flowability.

Patent Literature 8 discloses a highly thermally conductive resin composition in which liquid crystal polyester is mixed with talc, glass, and alumina that has a particle size distribution, which is a two extremal-valued distribution.

Patent Literature 9 discloses a technique in which a molded article having anisotropic thermal diffusivity is produced by injection molding of a resin composition made up of thermoplastic polyester resin, thermoplastic polyamide resin, and plate-like hexagonal boron nitride whose number average particle size is not smaller than 15 μm.

### CITATION LIST

### Patent Literatures

### [Patent Literature 1]

Japanese Patent No. 3948240 B (Japanese Patent Application Publication Tokukai No. 2003-41129 A, Publication date: Feb. 13, 2003)

### [Patent Literature 2]

Japanese Patent Application Publication Tokukaihei No. 2-160863 A (Publication date: Jun. 20, 1990)

### [Patent Literature 3]

Japanese Patent Application Publication Tokukai No. 2008-260830 A (Publication date: Oct. 30, 2008)

### [Patent Literature 4]

Japanese Patent Application Publication Tokukai No. 2009-185150 A (Publication date: Aug. 20, 2009)

### [Patent Literature 5]

Japanese Patent Application Publication Tokukai No. 2009-185151 A (Publication date: Aug. 20, 2009)

### [Patent Literature 6]

Japanese Patent Application Publication Tokukai No. 2009-185152 A (Publication date: Aug. 20, 2009)

### [Patent Literature 7]

Japanese Patent Application Publication Tokukai No. 2009-280725 A (Publication date: Dec. 3, 2009)

### [Patent Literature 8]

Japanese Patent Application Publication Tokukai No. 2009-263640 A (Publication date: Nov. 12, 2009)

### [Patent Literature 9]

International Publication No. WO 2009/116357 (Publication date: Sep. 24, 2009)

### SUMMARY OF INVENTION

### Technical Problem

However, since the highly thermally conductive resin composition disclosed in Patent Literature 3 contains the flattened cross-sectioned glass fiber, an aspect ratio of the glass fiber is high, and a flowability is therefore decreased in injection molding for producing a thin-walled molded article. This causes a problem that mechanical strength is decreased because orientation of resin crystals on outer and inner surfaces of the molded article becomes less uniform. Moreover, a frequency of equipment maintenance is increased because the glass fiber having such a shape causes greater abrasion on a screw and a die cavity in a cylinder during extrusion molding, injection molding, or the like. This leads to a problem of increase in cost. Similarly, according to the highly thermally conductive resin compositions disclosed in Patent Literatures 4 through 6, resin flowability in injection molding is decreased by the use of the flattened cross-sectioned glass fiber, and therefore (i) a mechanical characteristic of the molded article is deteriorated and (ii) cost is increased.

According to the highly thermally conductive resin composition disclosed in Patent Literature 7, the filler content is increased because five parts or more of the white pigment is contained. This causes decrease in flexural modulus of the resin composition, and it seems difficult to maintain a shape of an injection molded article.

According to the highly thermally conductive resin composition disclosed in Patent Literature 8, alumina contained in the resin composition causes greater abrasion on a screw and a die cavity in a cylinder during extrusion molding or injection molding. This leads to a problem of increase in cost.

Note that Patent Literature 9 does not disclose an example in which talc is used as the thermal conductive inorganic material.

The present invention is accomplished in view of the conventional problems, and an object of the present invention is to solve the problems and to provide (i) a highly thermally conductive resin molded article having excellent thermal conductivity and (ii) a method for manufacturing the highly thermally conductive resin molded article.

### Solution to Problem

As a result of diligent study on the object, the inventors have accomplished the present invention based on their own findings that (i) it is possible to obtain high thermal conductivity by adding platy talc particles, which have a number average particle size of 20 μm or larger, to thermoplastic polyester resin, and (ii) in particular, in a case where the platy talc particles are oriented in a surface direction in the highly thermally conductive resin molded article, thermal diffusivity of the highly thermally conductive resin molded article becomes high, and thermal conductivity is therefore further improved.

That is, in order to attain the object, a highly thermally conductive resin molded article of the present invention at least contains (A) thermoplastic polyester resin; (B) platy talc particles; and (C) a fiber reinforcement, (B) platy talc particle content falling within a range between 10% by volume and 60% by volume, where the entire composition is 100% by volume, a number average particle size of the (B) platy talc particles falling within a range between 20 μm and 80 μm, and the (B) platy talc particles being oriented in a surface direction of said highly thermally conductive resin molded article.

It is preferable that the highly thermally conductive resin molded article of the present invention has been molded by an injection molding method.

In the highly thermally conductive resin molded article of the present invention, it is desired that a volume ratio of the (B) platy talc particles is higher than that of the (C) fiber reinforcement.

In the highly thermally conductive resin molded article of the present invention a melt flow rate in injection molding of the highly thermally conductive resin composition falls within, for example, a range between 5 g/10 min and 200 g/10 min under a condition that a temperature is 280° C. and a load is 100 kgf.

In the highly thermally conductive resin molded article of the present invention, it is preferable that a tap density of the (B) platy talc particles is 0.60 g/ml or higher.

In the highly thermally conductive resin molded article of the present invention, it is preferable that an aspect ratio of a cross section of each of the (B) platy talc particles falls within a range between 5 and 30.

The highly thermally conductive resin molded article of the present invention preferably further contains (D) plate-like hexagonal boron nitride powder, (D) plate-like hexagonal boron nitride powder content falling within a range between 1% by volume and 40% by volume, where the entire composition is 100% by volume, and a number average particle size of the (D) plate-like hexagonal boron nitride powder being 15 μm or larger.

The highly thermally conductive resin molded article of the present invention preferably further contains (E) titanium oxide, (E) titanium oxide content falling within a range between 0.1% by volume and 5% by volume, where the entire composition is 100% by volume, and a number average particle size of the (E) titanium oxide being 5 μm or smaller.

In the highly thermally conductive resin molded article of the present invention, it is preferable that whiteness of said highly thermally conductive resin molded article is 80 or higher.

In the highly thermally conductive resin molded article of the present invention, it is preferable that (A) thermoplastic polyester resin content falls within a range between 35% by volume and 55% by volume, where the entire composition is 100% by volume.

In the highly thermally conductive resin molded article of the present invention, it is preferable that (C) fiber reinforcement content falls within a range between 5% by volume and 35% by volume, where the entire composition is 100% by volume.

In the highly thermally conductive resin molded article of the present invention, it is preferable that a surface direction thermal diffusivity, which is a thermal diffusivity in the surface direction of said highly thermally conductive resin molded article, is at least 1.6 times as high as a thickness direction thermal diffusivity which is a thermal diffusivity in a thickness direction that is perpendicular to the surface direction; and the surface direction thermal diffusivity is 0.5 mm²/sec or higher.

In the highly thermally conductive resin molded article of the present invention, it is preferable that a surface direction thermal diffusivity, which is a thermal diffusivity in the surface direction of said highly thermally conductive resin molded article, is at least 1.7 times as high as a thickness direction thermal diffusivity which is a thermal diffusivity in a thickness direction that is perpendicular to the surface direction; and the surface direction thermal diffusivity is 0.5 mm²/sec or higher.

In the highly thermally conductive resin molded article of the present invention, it is preferable that a volume resistivity value of said highly thermally conductive resin molded article is 10¹⁰ Ω·m or greater.

A method for manufacturing the highly thermally conductive resin molded article of the present invention includes the step of carrying out injection molding, in the step of carrying out injection molding, the (B) platy talc particles being oriented in the surface direction of the highly thermally conductive resin molded article.

### Advantageous Effects of Invention

The highly thermally conductive resin molded article of the present invention has excellent thermal conductivity.

### BRIEF DESCRIPTION OF DRAWINGS

FIG. 1 is a schematic view for explaining how to measure an aspect ratio of a platy talc particle in accordance with an embodiment of the present invention.

### DESCRIPTION OF EMBODIMENTS

The following description will discuss an embodiment of the present invention in detail. Note, however, that the scope of the present invention is not limited to the descriptions, and the present invention may be appropriately modified in a manner other than examples described below, to the extent of being not contrary to the purpose of the present invention.

(I) Composition of Highly Thermally Conductive Resin Molded Article of the Present Embodiment

The highly thermally conductive resin molded article of the present embodiment at least contains (A) thermoplastic polyester resin, (B) platy talc particles, and (C) a fiber reinforcement. It is preferable that the highly thermally conductive resin molded article of the present embodiment further contains (D) plate-like hexagonal boron nitride powder. Moreover, it is preferable that the highly thermally conductive resin molded article of the present embodiment further contains (E) titanium oxide. The following description will discuss details of the (A) thermoplastic polyester resin, the (B) platy talc particles, the (C) fiber reinforcement, the (D) plate-like hexagonal boron nitride powder, the (E) titanium oxide, and the like.

<(A) Thermoplastic Polyester Resin>

The highly thermally conductive resin molded article of the present embodiment at least contains (A) thermoplastic polyester resin. Examples of the (A) thermoplastic polyester resin used in the present embodiment encompass amorphous thermoplastic polyester resin such as amorphous aliphatic polyester, amorphous semiaromatic polyester, and amorphous wholly aromatic polyester; crystalline thermoplastic polyester resin such as crystalline aliphatic polyester, crystalline semiaromatic polyester, and crystalline wholly aromatic polyester; and liquid crystalline thermoplastic polyester resin such as liquid crystalline aliphatic polyester, liquid crystalline semiaromatic polyester, and liquid crystalline wholly aromatic polyester.

Note that, by containing the (A) thermoplastic polyester resin, the highly thermally conductive resin molded article of the present embodiment can have high whiteness. In a case where polyester resin is employed, whiteness tends to become higher as compared with a case where polyarylene sulfide resin, polyamide resin, or the like is employed.

<<Liquid Crystalline Thermoplastic Polyester Resin>>

Among the thermoplastic polyester resins, concrete examples of liquid crystalline thermoplastic polyester resin having a preferable structure encompass liquid crystalline polyester that is made up of at least one of the following structural units (I) through (IV):

Structural unit (I): —O-Ph-CO—
Structural unit (II): —O—R³—O—
Structural unit (III): —O—CH₂CH₂—O—
Structural unit (IV): —CO—R⁴—CO—
Note that “R³” in the above formula indicates at least one group selected from groups in the following Chemical Formula 1:

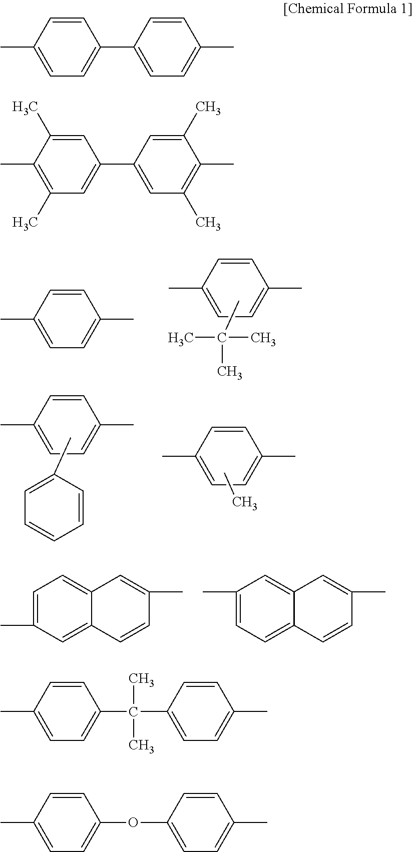

“R⁴” in the above formula indicates at least one group selected from groups in the following Chemical Formula 2:

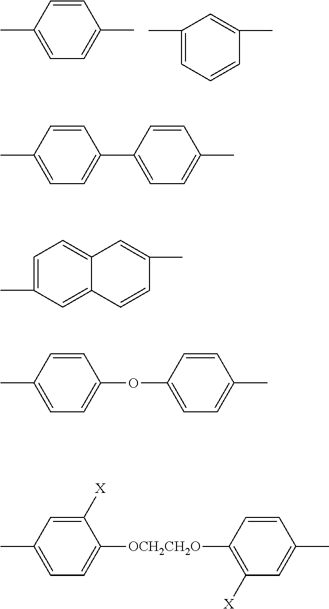

In Chemical Formula 2, “X” indicates a hydrogen atom or a chlorine atom.

Specifically, the structural unit (I) is produced from p-hydroxybenzoic acid. The structural unit (II) is produced from at least one aromatic dihydroxy compound selected from 4,4′-dihydroxybiphenyl, 3,3′,5,5′-tetramethyl-4,4′-dihydroxybiphenyl, hydroquinone, t-butylhydroquinone, phenylhydroquinone, methylhydroquinone, 2,6-dihydroxynaphthalene, 2,7-dihydroxynaphthalene, 2,2-bis(4-hydroxyphenyl)propane, and 4,4′-dihydroxydiphenyl ether. The structural unit (III) is produced from ethylene glycol. The structural unit (IV) is produced from at least one aromatic dicarboxylic acid selected from terephthalic acid, isophthalic acid, 4,4′-diphenyldicarboxylic acid, 2,6-naphthalene dicarboxylic acid, 1,2-bis(phenoxy)ethane-4,4′-dicarboxylic acid, 1,2-bis(2-chlorophenoxy)ethane-4,4′-dicarboxylic acid, and 4,4′-diphenyl ether dicarboxylic acid.

Among the above exemplified liquid crystalline polyesters, it is particularly preferable to employ (i) liquid crystalline polyester made up of a structural unit produced from p-hydroxybenzoic acid and 6-hydroxy-2-naphthoic acid, (ii) liquid crystalline polyester made up of a structural unit produced from p-hydroxybenzoic acid, a structural unit produced from ethylene glycol, a structural unit produced from an aromatic dihydroxy compound, and a structural unit produced from terephthalic acid, or (iii) liquid crystalline polyester made up of a structural unit produced from p-hydroxybenzoic acid, a structural unit produced from ethylene glycol, and a structural unit produced from terephthalic acid.

<<Crystalline Thermoplastic Polyester Resin>>

Among the thermoplastic polyester resins, concrete examples of the crystalline thermoplastic polyester resin encompass polyethylene terephthalate, polypropylene terephthalate, polybutylene terephthalate, polyethylene-2,6-naphthalate, polybutylene naphthalate, poly 1,4-cyclohexylenedimethylene terephthalate, polyethylene-1,2-bis(phenoxy)ethane-4,4′-dicarboxylate, and crystalline copolyester such as polyethylene isophthalate/terephthalate, polybutylene terephthalate/isophthalate, polybutylene terephthalate/decanedicarboxylate, and polycyclohexanedimethylene terephthalate/isophthalate.

Among the above crystalline polyesters, it is preferable to employ polyethylene terephthalate, polypropylene terephthalate, polybutylene terephthalate, polyethylene-2,6-naphthalate, polybutylene naphthalate, poly 1,4-cyclohexylenedimethylene terephthalate, or the like, because these compounds are easily available. Among these compounds, it is further preferable to employ polyalkylene terephthalate thermoplastic polyester resin such as polyethylene terephthalate, polypropylene terephthalate, or polybutylene terephthalate, because each of these compounds has an optimal crystallization speed.

The highly thermally conductive resin molded article of the present embodiment may be made of (i) a single kind of thermoplastic polyester resin or (ii) a combination of two or more kinds of thermoplastic polyester resin. In a case where the two or more kinds of thermoplastic polyester resin are combined, the combination is not limited to a particular one, and two or more components, which are different in feature such as chemical structure, molecular weight, and crystal form, can be arbitrarily combined with each other.

Among the various kinds of thermoplastic polyester resin, it is preferable to employ highly crystalline or liquid crystalline resin, because such resin itself has high thermal conductivity. Some kinds of resin have crystallinities that vary depending on molding conditions. In such a case, it is possible to increase thermal conductivity of a resultant resin molded article by selecting a molding condition with which a high crystallinity can be obtained.

It is preferable that a volume ratio of the (A) thermoplastic polyester resin falls within a range between 35% by volume and 55% by volume, where the entire composition is 100% by volume. In a case where the volume ratio of the (A) thermoplastic polyester resin is lower than 35% by volume, the volume ratio of the filler in the entire composition becomes too high, and this may cause decrease in properties such as flexural modulus, tensile strength, and impact strength. On the other hand, in a case where the volume ratio of the (A) thermoplastic polyester resin is higher than 55% by volume, adhesion between fillers in the molded article is deteriorated, and this may cause decrease in thermal conductivity because a path for conducting heat becomes difficult to form.

It is possible to use various kinds of thermoplastic resin, in addition to the (A) thermoplastic polyester resin, as a component in a resin composition from which the highly thermally conductive resin molded article of the present embodiment is produced. Such various kinds of thermoplastic resin other than the (A) thermoplastic polyester resin may be synthetic resin or natural resin. In a case where the thermoplastic resin is used in addition to the (A) thermoplastic polyester resin, it is preferable to use the thermoplastic resin by 0 to 100 parts by weight, more preferably, 0 to 50 parts by weight with respect to 100 parts by weight of the (A) thermoplastic polyester resin, in consideration of a balance between moldability and a mechanical characteristic.

Examples of the thermoplastic resin other than the (A) thermoplastic polyester resin encompass aromatic vinyl resin such as polystyrene; vinyl cyanide resin such as polyacrylonitrile; chlorine resin such as polyvinyl chloride; polymethacrylic acid ester resin such as polymethylmethacrylate; polyacrylic acid ester resin; polyolefin resin such as polyethylene, polypropylene, and cyclic polyolefin resin; polyvinyl ester resin such as polyvinyl acetate; polyvinyl alcohol resin; derivative resin of these; polymethacrylic acid resin, polyacrylic acid resin, and metal salt resin of these; poly conjugated diene resin; a polymer obtained by polymerizing maleic acid, fumaric acid, and derivatives thereof; a polymer obtained by polymerizing a maleimide compound; polycarbonate resin; polyurethane resin; polysulfone resin; polyalkylene oxide resin; cellulose resin; polyphenylene ether resin; polyphenylene sulfide resin; polyketone resin; polyimide resin; polyamidoimide resin; polyetherimide resin; polyether ketone resin; polyether ether ketone resin; polyvinyl ether resin; phenoxy resin; fluorine resin; silicone resin; a liquid crystal polymer; and a random/block/graft copolymer of the above exemplified polymers. The thermoplastic resin other than the (A) thermoplastic polyester resin can be used alone or in combination. In a case where two or more kinds of the thermoplastic resin are combined, it is possible to add a compatibilizer or the like as appropriate. The thermoplastic resin other than the (A) thermoplastic polyester resin may be selected as appropriate depending on purposes.

Among the thermoplastic resin other than the (A) thermoplastic polyester resin, it is preferable to employ thermoplastic resin which is (i) partially or wholly crystalline or (ii) partially or wholly liquid crystalline, because (i) a resultant resin composition will have high thermal conductivity and (ii) such resin can be easily mixed with the (B) platy talc particles, the (C) fiber reinforcement, and the (D) plate-like hexagonal boron nitride powder (details of (B) through (D) will be later described). The crystalline/liquid-crystalline thermoplastic resin may be wholly crystalline. Alternatively, the crystalline/liquid-crystalline thermoplastic resin may be partially crystalline/liquid-crystalline resin in which only a part of resin is crystalline/liquid-crystalline, i.e., only a particular block is crystalline/liquid-crystalline in molecules of a block/graft copolymer resin. Crystallinity of the crystalline/liquid-crystalline thermoplastic resin is not limited to a particular one. Alternatively, as the thermoplastic resin other than the (A) thermoplastic polyester resin, it is possible to employ a polymer alloy made up of (i) amorphous resin and crystalline resin or (ii) amorphous resin and liquid crystalline resin. Crystallinity of the amorphous resin and the crystalline/liquid-crystalline resin is not limited to a particular one.

The partially/wholly crystalline/liquid-crystalline thermoplastic resin other than the (A) thermoplastic polyester resin encompasses resin that shows an amorphous property when the resin is used alone or is molded under a particular molding process condition, even though the resin can be crystallized. In a case where such resin is employed, it may be possible to partially or wholly crystallize the resin (i) by appropriately selecting an adding amount of and an adding method of the (B) platy talc particles, the (C) fiber reinforcement, the (D) plate-like hexagonal boron nitride powder, and the like and (ii) by modifying a molding process method, i.e., by including processes such as a stretching process and a post-crystallization process.

In a case where elastic resin is employed as the thermoplastic resin other than the (A) thermoplastic polyester resin, it is possible to improve impact strength of the (A) thermoplastic polyester resin. For the sake of giving excellent impact strength to the resultant resin composition, the elastic resin preferably has at least one glass transition point that is not higher than 0° C., more preferably not higher than −20° C.

The elastic resin is not limited in particular, and examples of the elastic resin encompass diene rubbers such as polybutadiene, styrene-butadiene rubber, acrylonitrile-butadiene rubber, and (meth)acrylic acid alkyl ester-butadiene rubber; rubber polymers such as acrylic rubber, ethylene-propylene rubber, and siloxane rubber; a rubber copolymer obtainable by polymerizing (i) 10 to 90 parts by weight of diene rubber and/or rubber polymer, (ii) 10 to 90 parts by weight of at least one monomer selected from the group consisting of an aromatic vinyl compound, a vinyl cyanide compound, and (meta) acrylic acid alkyl ester, and (iii) 10 parts by weight or less of another vinyl compound that can be copolymerized with the at least one monomer; various kinds of polyolefin resin such as polyethylene and polypropylene; ethylene-α olefin copolymers such as an ethylene-propylene copolymer and an ethylene-butene copolymer; an olefin copolymer such as a propylene-butene copolymer; copolyolefin resin denatured by various copolymerized components such as an ethylene-ethyl acrylate copolymer; denatured polyolefin resin denatured by various functional components such as an ethylene-glycidyl methacrylate copolymer, an ethylene maleic anhydride copolymer, an ethylene-propylene-glycidyl methacrylate copolymer, an ethylene-propylene-maleic anhydride copolymer, an ethylene-butene-glycidyl methacrylate copolymer, an ethylene-butene-maleic anhydride copolymer, a propylene-butene-glycidyl methacrylate copolymer, and a propylene-butene-maleic anhydride copolymer; and styrene thermoplastic elastomers such as a styrene-ethylene-propylene copolymer, a styrene-ethylene-butene copolymer, and a styrene-isobutylene copolymer.

In a case where the elastic resin is added, the elastic resin is generally add by 150 parts by weight or less, preferably 0.1 to 100 parts by weight, more preferably, 0.2 to 50 parts by weight, with respect to 100 parts by weight of the (A) thermoplastic polyester resin. In a case where the addition amount is more than 150 parts by weight, properties such as rigidity, heat resistance, and thermal conductivity tend to decrease.

<(B) Platy Talc Particles>

The highly thermally conductive resin molded article of the present embodiment at least contains the (B) platy talc particles. The (B) platy talc particles employed in the present embodiment is not limited in particular in terms of locality, kind of impurity, and the like. In view of their thermal conductivity in addition to their electric insulation property, the (B) platy talc particles preferably have a number average particle size of 20 μm or larger, more preferably 30 μm or larger, further preferably 40 μm or larger.

In a case where a thermal diffusivity in a surface direction (hereinafter, referred to as “surface direction thermal diffusivity”) of the highly thermally conductive resin molded article of the present embodiment is (i) 0.70 mm²/sec or higher with a thickness of 1.0 mm and (ii) 0.50 mm²/sec or more with a thickness of 2.0 mm, the highly thermally conductive resin molded article of the present embodiment has excellent thermal conductivity. In a case where the surface direction thermal diffusivity of the highly thermally conductive resin molded article is 0.70 mm²/sec with the thickness of 1.0 mm, the number average particle size of the (B) platy talc particles is 20 μm, with reference to a graph (not illustrated) whose (i) horizontal axis is a number average particle size of platy talc particles and (ii) vertical axis is a surface direction thermal diffusivity. Moreover, in a case where the surface direction thermal diffusivity of the highly thermally conductive resin molded article is 0.50 mm²/sec with the thickness of 2.0 mm, the number average particle size of the (B) platy talc particles is also 20 μm, with reference to the graph. This shows that the number average particle size of the (B) platy talc particles needs to be 20 μm or more, in order to bring about the effect of the present invention.

As above described, as the number average particle size of the (B) platy talc particles becomes larger, thermal conduction anisotropy of a resultant molded article becomes greater. In general, an upper limit of the number average particle size of the (B) platy talc particles is 1.0 mm or less. In a case where the number average particle size is more than 1.0 mm, moldability tends to be decreased because, for example, a gate part of a mold is clogged with powder when injection molding is carried out. It is preferable that the number average particle size of the (B) platy talc particles is 0.2 mm or smaller, more preferably, 0.1 mm or smaller.

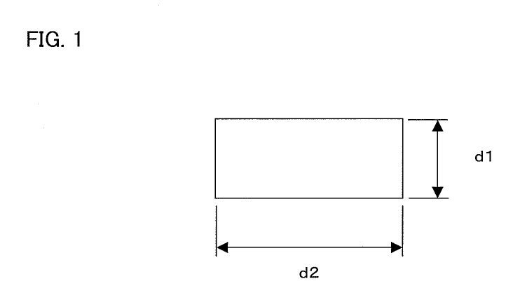

In view of thermal conductivity, each of the (B) platy talc particles employed in the present embodiment preferably has an aspect ratio falling within a range between 5 and 30. Here, the “aspect ratio” in this specification is a value represented by “d2/d1”, where “d1” is a minor axis of a platy talc particle and “d2” is a major axis of the platy talc particle (see FIG. 1). It is more preferable that the aspect ratio of the (B) platy talc particles of the present embodiment falls within a range between 8 and 20, in order to achieve anisotropy of thermal diffusivity. By employing platy talc particles having such an aspect ratio, the platy talc particles in a thin-walled part of a resultant molded article are oriented (aligned) in a surface direction (in which a surface of the resultant molded article lies) and accordingly the anisotropy of the thermal diffusivity is easily achieved in the part in which the platy talc particles are oriented. In a case where the aspect ratio is lower than 5, the platy talc particles are difficult to orient in the surface direction in the thin-walled part of the thermal conductivity resin molded article, and it may therefore be difficult to achieve the anisotropy. On the other hand, the platy talc particles with an aspect ratio higher than 30 is too long in its major axis direction, thereby adversely affecting resin flowability and accordingly deteriorating moldability.

A tap density of the (B) platy talc particles employed in the present embodiment is calculated with the use of a general powder tap density measuring device. Specifically, the tap density is calculated by a method in which (i) platy talc powder is put and tapped in a container of 100 cc for measuring density, so that the platy talc powder thus tapped is hardened by impact, and then (ii) excess powder on top of the container is rubbed off by a blade. As the tap density thus measured is higher, it is easier to add the platy talc particles to resin. It is preferable that the tap density is not less than 0.6 g/cm³, more preferably not less than 0.7 g/cm³, further preferably not less than 0.8 g/cm³.

In a case where the highly thermally conductive resin molded article of the present embodiment, which contains the (B) platy talc particles having the above described characteristics, has been molded by injection molding so that at least 50% by volume of the highly thermally conductive resin molded article has a thickness of 2.0 mm or less, it is possible to orient (align) most of the (B) platy talc particles in the surface direction of the highly thermally conductive resin molded article. By thus orienting the (B) platy talc particles, it is possible to cause the surface direction thermal diffusivity in the part having a thickness of 2.0 mm or less to be at least twice as high as a thermal diffusivity measured in a thickness direction. The (B) plate-like talc particles having the number average particle size of 20 μm or more have characteristics (i) of easily conducting heat in its plate surface direction and (ii) of being easily oriented so that its plate surface is along a surface direction of a molded article obtained by injection molding with the use of a die for producing a thin-walled molded article, as compared with powder having a smaller number average particle size. In a case where the (B) platy talc particles are thus oriented in the surface direction of the molded article, it is possible to bring about an excellent electric insulation property.

Here, “the (B) platy talc particles are oriented in a surface direction of the highly thermally conductive resin molded article” means that 75% by volume or more, more preferably 85% by volume or more, especially preferably 95% by volume or more of the entire (B) platy talc particles are aligned so that their plate surfaces are substantially in parallel with the surface direction of the highly thermally conductive resin molded article within ±30°, more preferably ±20°, further preferably ±10°. Note that the “surface direction of the highly thermally conductive resin molded article” means a direction in which a surface of the highly thermally conductive resin molded article lies, which surface has a largest surface area.

The fact that “the (B) platy talc particles are oriented in the surface direction of the highly thermally conductive resin molded article” can be confirmed as follows: that is, (i) the highly thermally conductive resin molded article is cut in a direction in parallel with its surface direction, (ii) the cross section thus obtained is observed with the use of a device such as SEM (Scanning Electron Microscope), and (iii) angles of the respective (B) platy talc particles are measured with the use of a device such as an image processing device.

The number average particle size of the (B) platy talc particles in this specification can be measured by any one of various measuring methods such as a laser light diffraction/scattering-diffraction method, an air permeability method, and a gas absorption method. The “number average particle size” in this specification means a number average median diameter (Dp50) obtained by any of the various measuring methods.

A volume ratio of the (B) platy talc particles falls within a range between 10% by volume and 60% by volume, where the entire composition is 100% by volume. In a case where the volume ratio is lower than 10% by volume, a total amount of talc becomes insufficient. This deteriorates orientation of the (B) platy talc particles, and accordingly the anisotropy of thermal diffusivity cannot be achieved. Consequently, the thermal conductivity is deteriorated. On the other hand, in a case where the volume ratio is higher than 60% by volume, a total amount of filler in the molded article becomes too large. This causes decrease in moldability, and accordingly a mechanical characteristic is significantly decreased. The volume ratio of the (B) platy talc particles preferably falls within a range between 10 and 60% by volume, more preferably 10 and 50% by volume, further preferably 10 and 45% by volume.

Note that, in general, the (B) platy talc particles are cheaper than the (D) plate-like hexagonal boron nitride powder, which will be later described.

<(C) Fiber Reinforcement>

The highly thermally conductive resin molded article of the present embodiment at least contains the (C) fiber reinforcement. As the (C) fiber reinforcement of the present embodiment, glass fiber is suitably employed. It is preferable to employ the glass fiber because a mechanical characteristic of the highly thermally conductive resin molded article is improved. It is preferable that the (C) fiber reinforcement has an average length falling within a range between 0.1 mm and 20 mm. In a case where the average length is shorter than 0.1 mm, the mechanical characteristic may not be improved. On the other hand, in a case where the average length is longer than 20 mm, the moldability may be deteriorated.

It is preferable that a volume ratio of the (C) fiber reinforcement falls within a range between 5% by volume and 35% by volume, where the entire composition is 100% by volume. The (C) fiber reinforcement may be subjected to a secondary fabrication in such a manner as to be in cloth form. In a case where the volume ratio of the (C) fiber reinforcement is lower than 5% by volume, an absolute quantity of fiber is too small. Therefore, it may be impossible to improve the strength. On the other hand, in a case where the volume ratio of the (C) fiber reinforcement is higher than 35% by volume, a total amount of filler is too large in the entire composition, and accordingly a resultant molded article may become fragile.

The (C) fiber reinforcement can be used alone or in combination. The (C) fiber reinforcement may be processed with the use of any of various couplers such as a silane coupler and a titanate coupler. In addition to the (C) fiber reinforcement, the highly thermally conductive resin molded article of the present embodiment may contain other filling material which has any of forms such as a plate form and a cloth form, to the extent of being not contrary to the purpose of the present embodiment.

<Plate-Like Hexagonal Boron Nitride Powder (D)>

It is preferable that the highly thermally conductive resin molded article of the present embodiment contains the (D) plate-like hexagonal boron nitride powder. The (D) plate-like hexagonal boron nitride powder employed in the present embodiment has a number average particle size of 15 μm or more, and can be produced by any of various known methods. As a general one of such various known methods, the following method can be used: that is, (i) boron sources such as boron oxide and boric acid are reacted with nitrogen sources such as melamine, urea, and ammonia as needed in advance, (ii) boron nitride having a turbostratic structure is synthesized by heating the reacted substance up to approximately 1000° C. in the presence of inert gas such as nitrogen or under vacuum, and (iii) the boron nitride is further crystallized by heating up to approximately 2000° C. in the presence of inert gas such as nitrogen and argon or under vacuum, so that hexagonal boron nitride crystal powder is obtained. By such a production method, it is possible to obtain plate-like hexagonal boron nitride that generally has a number average particle size of approximately 5 μm to 15 μm. On the other hand, the (D) plate-like hexagonal boron nitride employed in the present embodiment has a number average particle size of 15 μm or more, by enlarging a primary crystal size with the use of a special production method.

Specifically, the (D) plate-like hexagonal boron nitride powder having 15 μm or more of the number average particle size can be obtained as follows: that is, in an atmosphere of inert gas such as nitrogen or argon and in the presence of a flux compound, such as lithium nitrate, calcium carbonate, sodium carbonate, or metal silicon, which becomes liquid at a high temperature, (i) a boron source compound such as boric acid or boron oxide and (ii) (a) a nitrogen source compound such as melamine or urea or (b) nitrogen source gas such as nitrogen gas or ammonia gas are burned at approximately 1700° C. to 2200° C. for facilitating crystal growth in the flux compound so as to obtain crystal grains each of which has a larger grain size. Note, however, that the production method is not limited to this, and various kinds of methods can be employed.

In a case where 15% or less of the (D) plate-like hexagonal boron nitride powder contained in the highly thermally conductive resin molded article of the present embodiment are agglomerated particles each of which is made up of agglomerated plate-like particles, orientation of the (D) plate-like hexagonal boron nitride powder in the molded article is improved, and accordingly a thermal conductivity in a surface direction of the molded article can be set higher than a thermal conductivity in a thickness direction of the molded article. The ratio of the agglomerated particles is preferably 12% or lower, more preferably 10% or lower, most preferably 8% or lower.

The number average particle size of the (D) plate-like hexagonal boron nitride powder and the ratio of the agglomerated particles can be calculated as follows: that is, (i) at least 100 particles, more preferably at least 1000 particles of the (D) plate-like hexagonal boron nitride powder are observed with a scanning electron microscope and (ii) the particle size and the presence of agglomerated particles are measured from a captured image.

The ratio of the agglomerated particles contained in the highly thermally conductive resin molded article of the present embodiment can be calculated as follows: that is, (i) the molded article is left in an electrical furnace or the like for 30 minutes to 5 hours at a temperature between 550° C. and 2000° C., preferably between 600° C. and 1000° C. so as to remove resin components by burning, and then (ii) residual plate-like hexagonal boron nitride powder is observed with a scanning electron microscope. Even if the boron nitride powder is slightly agglomerated when the boron nitride powder is mixed with resin, a ratio of agglomerated particles may be reduced in the molded article because such agglomeration of powder is crushed when strong shearing force is applied to the resin composition in melting and kneading or in molding. Under the circumstances, the ratio of the agglomerated particles is confirmed by measuring powder extracted from the molded article. Note, however, that, in a case where inorganic components other than the resin and the plate-like hexagonal boron nitride powder are contained, an inorganic component other than boron nitride may (i) be melted at a high temperature and (ii) agglomerate the plate-like hexagonal boron nitride. In such a case, it is possible to measure the ratio of agglomerated particles, without unexpectedly changing an agglomeration state of the boron nitride powder, by selecting any of (i) a temperature at which the inorganic component other than boron nitride is not melted and (ii) a temperature at which the inorganic component other than boron nitride is decomposed and volatilized.

The ratio of agglomerated particles is calculated by counting the number of primary particles, which are not agglomerated, with respect to the total number of primary particles. Specifically, in a case where (i) 50 primary particles out of 100 primary particles are agglomerated and (ii) the other 50 primary particles are not agglomerated, the ratio of the agglomerated particle is 50%.

Note that, in a case where (i) a plate-like particle is observed such that the plate-like particle has a largest projected area and (ii) the plate-like particle appears to have a circular shape, the number average particle size is calculated based on a diameter of the circle. Alternatively, in a case where the plate-like particle has a shape other than the circular shape, a longest dimension of its plate surface is considered as a particle size. That is, (i) in a case where the plate-like particle has an elliptical shape, a length of a major axis of the ellipse is considered as a particle size, and (ii) in a case where the plate-like particle has a rectangular shape, a length of a diagonal line of the rectangle is considered as a particle size.

The “plate-like shape” of the particles is defined in this specification as follows: that is, (i) a major axis of a particle having the plate-like shape (i.e., a plate-like particle), which is observed such that the plate-like particle has a largest projected area, is at least 5 times as long as a shortest dimension of the plate-like particle which is observed such that the plate-like particle has a smallest projected area and (ii) the major axis of the plate-like particle, which is observed such that the plate-like particle has the largest projected area, is less than 5 times longer than a minor axis of the plate-like particle which is observed such that the plate-like particle has the largest projected area. It is preferable that the major axis of the plate-like particle, which is observed with the largest projected area, is longer than the shortest dimension of the plate-like particle observed with the smallest projected area by not less than 6 times, further preferably by not less than 7 times. It is preferable that, in the case where the plate-like particle is observed with the largest projected area, the major axis is longer than the minor axis by less than 4.5 times, further preferably by less than 4 times.

A tap density of the (D) plate-like hexagonal boron nitride powder is calculated with the use of a general powder tap density measuring device. Specifically, the tap density is calculated by a method in which (i) plate-like hexagonal boron nitride powder is tapped in a container of 100 cc for measuring density and is hardened by impact, and then (ii) excess powder on top of the container is rubbed off by a blade. As the tap density thus measured is higher, it is easier to add the plate-like hexagonal boron nitride powder to resin. It is preferable that the tap density is not less than 0.6 g/cm³, more preferably not less than 0.65 g/cm³, further preferably not less than 0.7 g/cm³, most preferably not less than 0.75 g/cm³.

It is preferable that a volume ratio of the (D) plate-like hexagonal boron nitride falls within a range between 1% by volume and 40% by volume, where the entire composition is 100% by volume. In a case where the volume ratio of the (D) plate-like hexagonal boron nitride is lower than 1% by volume, the (D) plate-like hexagonal boron nitride may not contribute to improvement in thermal conductivity. On the other hand, a case where the volume ratio of the (D) plate-like hexagonal boron nitride is higher than 40% by volume, a total amount of filler is too large, and accordingly a resultant molded article may become fragile.

<Ratio Between (A) Thermoplastic Polyester Resin, (B) Platy Talc Particles, (C) Fiber Reinforcement, and (D) Plate-Like Hexagonal Boron Nitride Powder>

In the thermoplastic resin composition constituting the highly thermally conductive resin molded article of the present embodiment, it is preferable that the (A) thermoplastic polyester resin, the (B) platy talc particles, the (C) fiber reinforcement, and the (D) plate-like hexagonal boron nitride powder are contained in the following volume ratio: (A)/{(B)+(C)+(D)}=90/10 to 30/70. As a used amount of (A) becomes larger, a resultant highly thermally conductive resin molded article tends to have improved impact resistance, surface property, and molding processability, and it therefore becomes easier to knead resin with the other components in carrying out melting and kneading. As a used amount of {(B)+(C)+(D)} becomes larger, thermal conductivity tends to be improved. In view of this, the volume ratio is preferably 85/15 to 33/67, further preferably 80/20 to 30/70, especially preferably 75/25 to 35/65, most preferably 70/30 to 35/65.

In the present embodiment, it is preferable that a volume ratio of the (B) platy talc particles is higher than that of the (C) fiber reinforcement. In general, a volume ratio of platy talc particles is lower than a fiber reinforcement. This is because a larger amount of platy talc particles cause decrease in strength. However, the present embodiment employs the (A) thermoplastic polyester resin which adheres to the (B) platy talc particles well. This makes it possible to increase the volume ratio of the (B) platy talc particles while maintaining high strength. Note that, in a case where the (D) plate-like hexagonal boron nitride powder is contained, it is preferable that a volume ratio of the (B) platy talc particles and the (D) plate-like hexagonal boron nitride powder is higher than that of the (C) fiber reinforcement.

Note, however, that, if the (C) fiber reinforcement is not contained in the highly thermally conductive resin molded article, the thermal conductivity will not be improved. In other words, in a case where the (C) fiber reinforcement is contained, the (C) fiber reinforcement fills gaps between the (B) platy talc particles and it is therefore possible to bring about a synergistic effect of high heat conductivity.

<Highly Thermally Conductive Inorganic Compound>

In order to enhance properties of the highly thermally conductive resin molded article of the present embodiment, the highly thermally conductive resin molded article can further contain a highly thermally conductive inorganic compound whose own thermal conductivity is 10 W/m·K or higher. In order to increase thermal conductivity of the highly thermally conductive resin molded article of the present embodiment, the thermal conductivity of the highly thermally conductive inorganic compound by itself is preferably 12 W/m·K or higher, further preferably 15 W/m·K or higher, especially preferably 20 W/m·K or higher, most preferably 30 W/m·K or higher. An upper limit of the thermal conductivity of the highly thermally conductive inorganic compound by itself is not limited in particular, and it is preferable that the thermal conductivity is as high as possible. Note that, in general, a highly thermally conductive inorganic compound having thermal conductivity of 3000 W/m·K or lower or 2500 W/m·K or lower is preferably used.

In a case where the highly thermally conductive resin molded article needs to have a high electric insulation property, a compound that shows electric insulation property is preferably used as the highly thermally conductive inorganic compound. The electric insulation property specifically indicates a property of having an electric resistivity of 1 Ω·cm or more. The electric insulation property of the compound employed in this case is preferably 10 Ω·cm or more, more preferably 10⁵ Ω·cm or more, further preferably 10¹⁰ Ω·cm or more, most preferably 10¹³ Ω·cm or more. An upper limit of the electric resistivity is not limited in particular but, in general, the electric resistivity is not more than 10¹⁸ Ω·cm. It is preferable that the highly thermally conductive resin molded article of the present embodiment has the electric insulation property that falls within the above described range.

Concrete examples of the highly thermally conductive inorganic compound, which is employed in the present embodiment and has the electric insulation property, encompass boron nitride; metal oxides such as aluminium oxide, magnesium oxide, oxidized silicon, beryllium oxide, copper oxide, and cuprous oxide; metal nitrides such as aluminium nitride and silicon nitride; metallic carbide such as silicon carbide; metal carbonate such as magnesium carbonate; insulating carbon materials such as diamond; metal hydroxides such as aluminium hydroxide and magnesium hydroxide; various boron nitrides such as cubic boron nitride and turbostratic boron nitride which have forms other than the (D) plate-like hexagonal boron nitride powder. Moreover, the aluminium oxide may be a compound which is combined with other element such as mullite.

Among the above exemplified compounds, it is preferable to use boron nitride other than the (D) plate-like hexagonal boron nitride powder; metal nitrides such as aluminum nitride and silicon nitride; metal oxides such as aluminium oxide, magnesium oxide, and beryllium oxide; metal carbonate such as magnesium carbonate; metal hydroxides such as aluminium hydroxide and magnesium hydroxide; and insulating carbon materials such as diamond, because of their excellent electric insulation property. Among the aluminium oxide, α-alumina is preferably used because of its excellent thermal conductivity. Each of those compounds can be used alone or in combination.

Such highly thermally conductive inorganic compounds can have various forms. Examples of the various forms encompass a particle form, a fine-particle form, a nanoparticle form, an agglomerated-particle form, a tube form, a nanotube form, a wire form, a rod form, a needle form, a plate form, an indefinite form, a rugby-ball form, a hexahedron form, a composite particle form containing larger particles and finer particles, and a liquid form. Moreover, the highly thermally conductive inorganic compounds may be natural products or synthetic products. In a case of the natural products, localities and the like are not limited in particular, and can be selected as appropriate. Note that each one of the highly thermally conductive inorganic compounds can be used alone. Alternatively, two or more of the highly thermally conductive inorganic compounds, which are different in form, average particle size, kind, surface-treatment agent, and the like, can be used together.

The highly thermally conductive inorganic compounds may be subjected to a surface treatment with any of various surface-treatment agents such as a silane processing agent, in order to (i) enhance interfacial adhesiveness between resin and the inorganic compound and (ii) ease workability. The surface-treatment agent is not limited to a particular one, and it is possible to use a conventionally known agent such as a silane coupling agent and a titanate coupling agent. Among those, it is preferable to use a silane coupling agent such as (i) an epoxy group containing silane coupling agent such as epoxysilane, (ii) an amino group containing silane coupling agent such as aminosilane, or (iii) polyoxyethylenesilane, because such silane coupling agents hardly deteriorate properties of resin. A method for carrying out the surface treatment on the inorganic compound is not limited in particular, and a general treatment method can be employed.

<Titanium Oxide (E)>

It is preferable that the highly thermally conductive resin molded article of the present embodiment contains (E) titanium oxide. (E) titanium oxide employed in the present embodiment preferably has a number average particle size of 0.01 μm or larger and 5 μm or smaller. The number average particle size of the (E) titanium oxide is more preferably 0.05 μm or larger and 3 μm or smaller, further preferably 0.05 μm or larger and 2 μm or smaller. In a case where the average particle size is larger than 5 μm, flowability of resin may be decreased because particles having such a large particle size are to exist in the composition. On the other hand, titanium oxide having a number average particle size smaller than 0.01 μm is high in manufacturing cost.

The number average particle size of the (E) titanium oxide in this specification can be measured by any one of various measuring methods such as a laser light diffraction/scattering-diffraction method, an air permeability method, and a gas absorption method. The “number average particle size” in this specification means a number average median diameter (Dp50) obtained by any of the various measuring methods.

A volume ratio of the (E) titanium oxide preferably falls within a range between 0.1% by volume and 5.0% by volume, where the entire composition is 100% by volume in total. In a case where the volume ratio of the (E) titanium oxide falls within the range, (i) the highly thermally conductive resin molded article can maintain 80 or more of whiteness W and (ii) the composition can secure resin flowability. The “whiteness W” can be calculated by Formula (1) later described.

In a case where the volume ratio of the (E) titanium oxide is lower than 0.1% by volume, a whitening effect of titanium is deteriorated, and the whiteness W may fall below 80. On the other hand, in a case where the volume ratio of the (E) titanium oxide is higher than 5.0% by volume, strength may be decreased.

<Other Inorganic Compound>

In order to enhance properties such as heat resistance and mechanical strength of the resin composition used in the highly thermally conductive resin molded article of the present embodiment, it is possible to further add an inorganic compound (hereinafter, referred to as “other inorganic compound”) other than the above described inorganic compound to the resin composition, to the extent of being not contrary to the purpose of the present embodiment. Such other inorganic compound is not limited to a particular one. Note, however, that, in a case where said other inorganic compound is added, said other inorganic compound can affect the thermal conductivity. Under the circumstances, it is necessary to carefully determine an addition amount and the like of said other inorganic compound. Said other inorganic compound may be subjected to surface treatment. In a case where said other inorganic compound is used, it is preferable to add said other inorganic compound by not more than 100 parts by weight with respect to 100 parts by weight of the (A) thermoplastic polyester resin. If the addition amount is more than 100 parts by weight, impact resistance and molding processability may be decreased. Moreover, the addition amount of said other inorganic compound is preferably not more than 50 parts by weight, more preferably not more than 10 parts by weight. Note that, as the addition amount of said other inorganic compound increases, a surface property and dimensional stability of a resultant molded article tend to be deteriorated. Therefore, in a case where such characteristics are important for the resultant molded article, it is preferable to set the addition amount of said other inorganic compound as small as possible.

<Injection Molding>

It is preferable that the highly thermally conductive resin molded article of the present embodiment is produced by a general injection molding method. Here, the “injection molding method” is a method for obtaining a molded product (molded article) by (i) attaching a die to an injection molding machine, (ii) injecting a resin composition, which has been melt and plasticated in the injection molding machine, into a die cavity, and (iii) cooling the resin composition so that the resin composition is hardened.

The highly thermally conductive resin molded article of the present embodiment has a configuration in which the (B) platy talc particles are arranged in a surface direction of the highly thermally conductive resin molded article. The resin material of the highly thermally conductive resin molded article of the present embodiment, which resin material contains the (A) thermoplastic polyester resin and the (B) platy talc particles, has excellent resin flowability when melted. This makes it possible to obtain the highly thermally conductive resin molded article even at a medium injection speed. Specifically, the highly thermally conductive resin molded article can be obtained at an injection speed of not lower than 50 mm/s. The injection speed is preferably a medium speed or higher, i.e., not lower than 80 mm/s, more preferably 100 mm/s. The resin composition used to produce the highly thermally conductive resin molded article of the present embodiment has good resin flowability in being injected. Therefore, the (B) platy talc particles in the resin composition are more likely to be oriented in the surface direction of the highly thermally conductive resin molded article even at the medium injection speed. In a case where the injection speed is set to be higher, the (B) platy talc particles are further likely to be oriented in the surface direction of the highly thermally conductive resin molded article. In a case where the medium injection speed as above described is employed, a resin material used to produce a conventional highly thermally conductive resin molded article cannot be molded by an injection molding. However, the highly thermally conductive resin molded article of the present invention, which is made of the above described materials and has the above described composition, can be produced by the injection molding.

As above described, the highly thermally conductive resin molded article of the present embodiment has the characteristic configuration that is different from that of a conventional resin molded article. Specifically, the highly thermally conductive resin molded article of the present embodiment at least includes the (A) thermoplastic polyester resin, the (B) platy talc particles, and the (C) fiber reinforcement, wherein a volume ratio of the (B) platy talc particles falls within a range between 10% by volume and 60% by volume, and a number average particle size of the (B) platy talc particles is 20 μm or larger. With the configuration, the highly thermally conductive resin molded article of the present embodiment can be produced by the injection molding.

(II) Method for Manufacturing Highly Thermally Conductive Resin Molded Article of the Present Embodiment

A method for manufacturing the highly thermally conductive resin molded article of the present embodiment is not limited to a particular one. For example, the highly thermally conductive resin molded article can be manufactured by (i) drying the above described components (such as the (A) thermoplastic polyester resin, the (B) platy talc particles, the (C) fiber reinforcement, the (D) plate-like hexagonal boron nitride powder, and the (E) titanium oxide), an additive agent, and the like, and then (ii) melting and mixing dried components by a melt-kneading machine such as a single or twin screw extruder. In a case where the components are in liquid form, the components can be fed to the melt-kneading machine with the use of a device such as a liquid feeding pump during the mixing.

It is preferable that the method for manufacturing the highly thermally conductive resin molded article of the present embodiment includes the step of carrying out injection molding by which the highly thermally conductive resin molded article is made to at least partially have a thickness of 2.0 mm or less.

It is possible to add, as appropriate, a crystallization accelerator such as a nucleating agent to the resin composition used to produce the highly thermally conductive resin molded article of the present embodiment. This makes it possible to further improve moldability.

Examples of the crystallization accelerator used in the present embodiment encompass higher fatty acid amides, urea derivatives, sorbitol compounds, higher fatty acid salts, and aromatic fatty acid salts. These compounds can be used alone or in combination of two or more of these. Among these compounds, higher fatty acid amides, urea derivatives, and sorbitol compounds are preferable because of their higher performances as the crystallization accelerator.

Examples of higher fatty acid amides encompass behenic acid amide, oleic amide, erucic acid amide, stearic acid amide, palmitic acid amide, N-stearylbehenic acid amide, N-stearylerucic acid amide, ethylenebisstearic acid amide, ethylenebisoleic amide, ethylenebiserucic acid amide, ethylenebislauryl acid amide, ethylenebiscapric acid amide, p-phenylenebisstearic acid amide, and polycondensates of ethylenediamine, stearic acid, and sebacic acid. In particular, behenic acid amide is preferably used.

Examples of urea derivatives encompass bis(stearylureido)hexane, 4,4′-bis(3-methylureido)diphenylmethane, 4,4′-bis(3-cyclohexylureido)diphenylmethane, 4,4′-bis(3-cyclohexylureido)dicyclohexylmethane, 4,4′-bis(3-phenylureido)dicyclohexylmethane, bis(3-methylcyclohexylureido)hexane, 4,4′-bis(3-decylureido)diphenylmethane, N-octyl-N′-phenylurea, N,N′-diphenylurea, N-tolyl-N′-cyclohexylurea, N,N′-dicyclohexylurea, N-phenyl-N′-tribromophenylurea, N-phenyl-N′-tolylurea, and N-cyclohexyl-N′-phenylurea. In particular, bis(stearylureido)hexane is preferably used. Examples of sorbitol compounds encompass 1,3,2,4-di(p-methylbenzylidene)sorbitol, 1,3,2,4-dibenzylidenesorbitol, 1,3-benzylidene-2,4-p-methylbenzylidenesorbitol, 1,3-benzylidene-2,4-p-ethylbenzylidenesorbitol, 1,3-p-methylbenzylidene-2,4-benzylidenesorbitol, 1,3-p-ethylbenzylidene-2,4-benzylidenesorbitol, 1,3-p-methylbenzylidene-2,4-p-ethylbenzylidenesorbitol, 1,3-p-ethylbenzylidene-2,4-p-methylbenzylidenesorbitol, 1,3,2,4-di(p-ethylbenzylidene)sorbitol, 1,3,2,4-di(p-n-propylbenzylidene)sorbitol, 1,3,2,4-di(p-i-propylbenzylidene)sorbitol, 1,3,2,4-di(p-n-butylbenzylidene)sorbitol, 1,3,2,4-di(p-s-butylbenzylidene)sorbitol, 1,3,2,4-di(p-t-butylbenzylidene)sorbitol, 1,3,2,4-di(p-methoxybenzylidene)sorbitol, 1,3,2,4-di(p-ethoxybenzylidene)sorbitol, 1,3-benzylidene-2,4-p-chlorbenzylidenesorbitol, 1,3-p-chlorbenzylidene-2,4-benzylidenesorbitol, 1,3-p-chlorbenzylidene-2,4-p-methylbenzylidenesorbitol, 1,3-p-chlorbenzylidene-2,4-p-ethylbenzylidenesorbitol, 1,3-p-methylbenzylidene-2,4-p-chlorbenzylidenesorbitol, 1,3-p-ethylbenzylidene-2,4-p-chlorbenzylidenesorbitol, and 1,3,2,4-di(p-chlorbenzylidene)sorbitol. Among these compounds, 1,3,2,4-di(p-methylbenzylidene)sorbitol and 1,3,2,4-dibenzylidenesorbitol are preferably used.

In view of moldability, it is preferable that the resin composition used to produce the highly thermally conductive resin molded article of the present embodiment contains the crystallization accelerator by 0.01 part by weight to 5 parts by weight with respect to 100 parts by weight of the (A) thermoplastic polyester resin, more preferably by 0.03 part by weight to 4 parts by weight, further preferably by 0.05 part by weight to 3 parts by weight. In a case where the used amount of the crystallization accelerator is less than 0.01 part by weight, the crystallization accelerator may insufficiently bring about its effect. On the other hand, in a case where the used amount is more than 5 parts by weight, the effect of the crystallization accelerator may be saturated, and this is not economically preferable. Further, in the case where the used amount is more than 5 parts by weight, an appearance and properties of the highly thermally conductive resin molded article may be deteriorated.

In order for the highly thermally conductive resin molded article of the present embodiment to achieve a higher performance, the highly thermally conductive resin molded article preferably contains one or more thermal stabilizers such as phenolic stabilizer, a sulfuric stabilizer, and a phosphorus stabilizer. Further, if needed, the highly thermally conductive resin molded article may contain one or more generally-known agents such as a stabilizer, a lubricant, a mold release agent, a plasticizer, a flame retarder other than a phosphorus flame retarder, a flame retardant promoter, an ultraviolet absorbent, a light stabilizer, a dye, an antistatic agent, an electrical conductivity imparting agent, a dispersion agent, a compatibilizer, and an antibacterial agent.

(III) Properties of Highly Thermally Conductive Resin Molded Article of the Present Embodiment

<Whiteness>

The highly thermally conductive resin molded article of the present embodiment preferably has whiteness of not less than 80, more preferably of not less than 83. In a case where the whiteness of the highly thermally conductive resin molded article is not less than 80, the highly thermally conductive resin molded article can be applied to members of a lighting apparatus such as a light bulb socket and a luminous tube holder.

In this specification, the “whiteness W” indicates a value that can be calculated based on the following formula (1), where “L” is a brightness of color, “a” is a hue, and “b” is a color saturation of powder which are measured by the use of a color and color-difference meter.

W=100−{(100−L)²+a²+b²}^{1/2} (1)

<Thickness of Molded Article>

It is necessary that 50% by volume or more of the highly thermally conductive resin molded article of the present embodiment has a thickness of 2.0 mm or less. In a case where a part of the highly thermally conductive resin molded article, which part has a thickness of 2.0 mm or less, forms a large proportion of the highly thermally conductive resin molded article, a difference between thermal diffusivities in a surface direction and a thickness direction of the molded article. This allows the molded article to easily have anisotropic thermal diffusivity and to contribute to a reduction in thickness and weight of a mobile electronic device. A ratio between the part having the thickness of 2.0 mm or less and the other part can be determined as appropriate by taking into consideration a strength, a design, and the like of the molded article. The part having the thickness of 2.0 mm or less preferably accounts for 55% by volume in the total volume, more preferably for 60% by volume, most preferably for 70% by volume of the molded article. Moreover, it is preferable that 50% by volume or more of the molded article has a thickness of 1.8 mm or less, more preferably 1.3 mm or less, further preferably 1.1 mm or less, most preferably 1.0 mm or less. On the other hand, in a case where the molded article is too thin, a molding may be difficult to carry out and the molded article may become weak with respect to impact. In view of this, the molded article preferably has a thickness of not less than 0.5 mm, more preferably not less than 0.55 mm, most preferably not less than 0.6 mm. Note that the molded article may entirely have a uniform thickness or have a thicker part and a thinner part.

The molded article having such a thickness can be produced by any of various thermoplastic resin molding method such as injection molding, extrusion molding, press molding, and blow molding. Among these methods, it is preferable to employ the injection molding, for the reasons such as that (i) a shear rate on the resin composition in molding is high and the molded article can easily have anisotropic thermal diffusivity and (ii) a molding cycle is short and therefore excellent productivity can be obtained. An injection molding machine, a die, and the like used in this case are not limited to particular ones. However, it is preferable to use a die which is designed so that 50% by volume or more of a resultant molded article can have a thickness of 2.0 mm or less.

<Thermal Diffusivity>

It is possible to measure anisotropy of thermal diffusivities, in the surface direction and in the thickness direction, of the part of the highly thermally conductive resin molded article which part has the thickness of 2.0 mm or less by, for example, the following method. That is, with the use of a flash type thermal diffusivity measuring device, (i) a plate-like sample is heated up by irradiating a surface of the plate-like sample with a laser or light and (ii) temperature rise is measured in (a) a part which is on a backside of the heated-up part and is located just behind the heated-up part and (b) another part which is on the backside and is slightly away from the heated-up part in a surface direction of the plate-like sample. In order to suppress a temperature rise on the surface of the plate-like sample while the measurement is carried out, it is preferable to carry out the measurement with the use of a xenon flash type thermal diffusivity measuring device. In a case where (i) the surface direction thermal diffusivity and the thickness direction thermal diffusivity thus measured are compared with each other and (ii) the surface direction thermal diffusivity is at least twice as high as the thickness direction thermal diffusivity, it is possible to efficiently diffuse heat in the surface direction, which heat is generated at a heat spot inside a device such as a mobile electronic device. The surface direction thermal diffusivity is preferably at least 1.6 times as high as the thickness direction thermal diffusivity, more preferably at least 1.7 times, especially preferably at least 1.8 times. In a case where the surface direction thermal diffusivity is at least 1.6 times as high as the thickness direction thermal diffusivity, it is possible to efficiently discharge heat, which is generated inside a heating element, to the outside.

In order to efficiently discharge heat, which is generated inside a mobile electronic device or the like, to the outside, it is necessary to increase an absolute value of thermal diffusivity of the molded article itself. Specifically, the surface direction thermal diffusivity of the molded article needs to be not less than 0.5 mm²/sec. The surface direction thermal diffusivity is preferably not less than 0.70 mm²/sec, more preferably 0.80 mm²/sec.

<Volume Resistivity Value>

The highly thermally conductive resin molded article of the present embodiment has both the electric insulation property and the high thermal conductivity. Therefore, the highly thermally conductive resin molded article is particularly effectively applicable to a use in which, conventionally, metal could not be employed because the metal has high thermal conductivity but does not have an insulation property. A volume resistivity value of the molded article, which is measured in accordance with ASTM D-257, needs to be not less than 10¹⁰ Ω·cm, preferably not less than 10¹¹ Ω·cm, more preferably not less than 10¹² Ω·cm, further preferably not less than 10¹³ Ω·cm, most preferably not less than 10¹⁴ Ω·cm.

<Melt Flow Rate>

The resin composition used to produce the highly thermally conductive resin molded article of the present embodiment preferably has, in molding, a melt flow rate of not lower than 5 g/10 min and not higher than 200 g/10 min, more preferably of not lower than 5 g/10 min and not higher than 150 g/10 min. In a case where the melt flow rate is lower than 5 g/10 min, it may be difficult to mold the thin-walled part. On the other hand, in a case where the melt flow rate is higher than 200 g/10 min, a burr is more likely to occur because the flowability in the die cavity becomes too high and such a burr may scratch a die parting surface. In this specification, the “melt flow rate” indicates a value that is measured with the use of a Koka-type flow tester (manufactured by Shimadzu Corporation, model number: CFT-500C) under a condition that a measurement temperature is 280° C. and a load is 100 kgf.

According to the highly thermally conductive resin molded article of the present embodiment, the melt flow rate tends to be decreased as the (B) platy talc particles become larger. Moreover, in a case where a content ratio of the (B) platy talc particles in the highly thermally conductive resin molded article is increased by further adding (B) platy talc particles instead of adding the (D) plate-like hexagonal boron nitride powder, it is possible to heighten the melt flow rate. As a result, the moldability is improved and the platy talc particles can be aligned more easily.

The highly thermally conductive resin molded article of the present embodiment (i) is excellent in thermal conductivity, insulation property, mechanical strength, flowability, and whiteness, (ii) has a low density, (iii) and can be produced with reduced abrasion on a die, which is used to produce the highly thermally conductive resin molded article.

Note that the present invention is not limited to the embodiments, but can be altered by a skilled person in the art within the scope of the claims. An embodiment derived from a proper combination of technical means appropriately modified within the scope of the claims is also encompassed in the technical scope of the present invention.

### EXAMPLES

The following description will discuss concrete Examples of the present invention and Comparative Examples. Note that the present invention is not limited to Examples below.

### Example 1

A mixture (raw material 1) was prepared by mixing 0.2 part by weight of a phenolic stabilizer AO-60 (manufactured by ADEKA CORPORATION) with 100 parts by weight of polyethylene terephthalate resin (thermoplastic polyester resin (A-1): manufactured by Mitsubishi Chemical Corporation, Novapex PBK II). Another mixture (raw material 2) was prepared by (I) mixing, by using a super floater, (i) 41 parts by weight of platy talc particles (platy talc particles (B-1): manufactured by Nippon Talc Co., Ltd., MS-KY), (ii) 26 parts by weight of glass chopped strands (fiber reinforcement (C-1): manufactured by Nippon Electric Glass Co., Ltd., ECS03T-187HPL), (iii) 1 part by weight of epoxysilane (manufactured by Shin-Etsu Chemical Co., Ltd., KBM-303), and (iv) 5 parts by weight of ethanol, (II) stirring the mixture for 5 minutes, and then (III) drying the mixture at 80° C. for four hours.

The raw material 1 and the raw material 2 were (i) set in respective gravimetric feeders and mixed so that a volume ratio (A)/{(B)+(C)} becomes 50/50, and then (ii) fed to a feed opening (hopper) provided in the vicinity of base parts of screws of an intermeshed co-rotation twin screw extruder (manufactured by Japan Steel Works, Ltd., TEX44XCT). A temperature set in the vicinity of the feed opening was 250° C., and the temperature was gradually increased toward tips of the screws of the extruder so that a temperature of the tips of the screws was set to 280° C. Sample pellets for injection were thus obtained under the above condition.

The sample pellets thus obtained were (i) dried at 140° C. for four hours and then (ii) fed to a 75 t injection molding machine. In the 75 t injection molding machine, the sample pellets were molded into a first flat-shaped test piece having dimensions of 150 mm×80 mm×(thickness of) 1.0 mm and a second flat-shaped test piece having dimensions of 50 mm×80 mm×(thickness of) 2.0 mm through a pin gate which was located in a center of a flat plate surface and had a gate size of 0.8 mmφ. Highly thermally conductive resin molded articles having thermal conduction anisotropy were thus obtained.

### Examples 2 through 8 and Comparative Examples 1 through 8

Highly thermally conductive resin molded articles of Examples 2 through 8 and Comparative Examples 1 through 8 were obtained in manners similar to that of Example 1, except that types and amounts of raw materials were changed as indicated in Table 1 below.

[Raw materials used in Examples 1 through 8 and Comparative Examples 1 through 8]

The following show raw materials used in Examples 1 through 8 and Comparative Examples 1 through 8.

(A) Thermoplastic Polyester Resin:

(A-1): polyethylene terephthalate resin (manufactured by Mitsubishi Chemical Corporation, Novapex PBK II)
(A-2): polyphenylene sulfide resin (manufactured by Dainippon Ink and Chemicals (DIC) Inc., C-201)

(B) Platy Talc Particles:

(B-1): platy talc particles (manufactured by Nippon Talc Co., Ltd., number average particle size of 23 μm, aspect ratio of 10, tap density of 0.70 g/ml, MS-KY)
(B-2): platy talc particles (manufactured by Nippon Talc Co., Ltd., number average particle size of 7.3 μm, aspect ratio of 4, tap density of 0.50 g/ml, MSK-1B)
(B-3): platy talc particles (manufactured by Asada Milling Co., Ltd., number average particle size of 15 μm, aspect ratio of 4, tap density of 0.55 g/ml, SW-AC)
(B-4): platy talc particles (manufactured by Nippon Talc Co., Ltd., number average particle size of 40 μm, aspect ratio of 10, tap density of 0.75 g/ml, NK talc)

(C) Fiber Reinforcement:

(C-1): glass fiber (manufactured by Nippon Electric Glass Co., Ltd., thermal conductivity of 1.0 W/m·K by itself, fiber diameter of 13 μm, number average fiber length of 3.0 mm, having electric insulation property, volume resistivity value of 10¹⁵ Ω·cm, ECS03T-187H/PL)

(D) Plate-Like Hexagonal Boron Nitride:

(D-1): plate-like hexagonal boron nitride powder (number average particle size of 48 μm, agglomerated particle ratio of 6.1%, tap density of 0.77 g/cm³, thermal conductivity of 300 W/mK by itself (measured in a hardened state), having electric insulation property)

(E) Titanium Oxide:

(E-1): titanium oxide (manufactured by Ishihara Sangyo Kaisha, Ltd., number average particle size of 0.21 μm, CR-60)

Other Additive Agent:

(F-1): phosphorus flame retarder (manufactured by Clariant in Japan, OP-935)
(F-2): bromine flame retarder (manufactured by Albemarle Japan Corporation, BT-93W)
(F-3): flame retardant promoter (manufactured by Nihon Seiko Co., Ltd., antimony trioxide, PATOX-p)

(G) Sheet Mica:

(G-1): sheet mica (manufactured by Yamaguchi Mica Co., Ltd., number average particle size of 23 μm, aspect ratio of 70, tap density of 0.13 g/ml, A-21S)

[Example of how to Produce Plate-Like Hexagonal Boron Nitride]

A compound was prepared by (i) mixing 53 parts by weight of orthoboric acid, 43 parts by weight of melamine, and 4 parts by weight of lithium nitrate by a Henschel mixer, (ii) adding 200 parts by weight of pure water to the mixture and then stirring the mixture at 80° C. for 8 hours, (iii) filtrating the stirred mixture, and then (iv) drying the filtrated mixture at 150° C. for 1 hour. The resultant compound was heated at 900° C. for 1 hour in an atmosphere of nitrogen, and further burned at 1800° C. in the atmosphere of nitrogen so as to crystallize the compound. The resultant burned product was crushed so as to obtain plate-like hexagonal boron nitride powder (D-1). The plate-like hexagonal boron nitride powder (D-1) had (i) a number average particle size of 48 μm, (ii) an agglomerated particle ratio of 6.1%, and (iii) tap density of 0.77 g/cm³. The plate-like hexagonal boron nitride powder (D-1) alone was hardened, and thermal conductivity of the plate-like hexagonal boron nitride powder (D-1) thus hardened was measured. As a result, the thermal conductivity was 300 W/mK, and the plate-like hexagonal boron nitride powder (D-1) had an electric insulation property.

[Thermal Diffusivity]

The highly thermally conductive resin molded articles obtained as above and having thicknesses of 1.0 mm and 2.0 mm, respectively, were cut so that discoid samples each having a size of 12.7 mmφ were prepared. Laser light absorbing spray (manufactured by Fine Chemical Japan Co., LTD., Blackguard spray FC-153) was applied to surfaces of the discoid samples and then the discoid samples were dried. Subsequently, a thickness direction thermal diffusivity and a surface direction thermal diffusivity of the discoid samples were measured with the use of an Xe flash analyzer (manufactured by NETZSCH Inc., LFA447 Nanoflash).

[Electric Insulation Property]

Volume resistivity values of the highly thermally conductive resin molded articles having thicknesses of 1.0 mm and 2.0 mm, respectively, were measured in accordance with ASTM D-257.

[Whiteness]

The highly thermally conductive resin molded articles having thicknesses of 1.0 mm and 2.0 mm, respectively, were processed into samples that have shapes fitting for respective sample cells, each of which was made of quartz glass and had a diameter of 30 mm and a height of 13 mm. Then, the samples were fed to the respective sample cells, and whiteness W was calculated based on the foregoing formula (1) by measuring a brightness of color (L), a hue (a), and a color saturation (b) with the use of a color and color-difference meter (manufactured by Nippon Denshoku Industries Co., Ltd., SE-2000).

[Melt Flow Rate (MFR)]

A melt flow rate was measured with the use of a Koka-type flow tester (manufactured by Shimadzu Corporation, model number: CFT-500C) under a condition that a measurement temperature was 280° C. and a load was 100 kg.

[Izod Impact Strength]

In accordance with ASTM D256m, Izod impact strength with notch was measured.

### Results of Examples 1 through 8 and Comparative Examples 1 through 8

The following Table 1 shows results of Examples 1 through 8 and Comparative Examples 1 through 8.

TABLE 1

| | Number/ | Example | | | | | | | |
|---|---|---|---|---|---|---|---|---|---|
| | Unit | 1 | 2 | 3 | 4 | 5 | 6 | 7 | 8 |
| (A) Thermoplastic polyester resin | A-1 | 49 | 49 | 50 | 49 | 48 | 46 | 40 | 49 |
| Thermoplastic polyphenylene sulfide resin | A-2 | | | | | | | | |
| (B) Platy talc particles | B-1 | 30 | | 15 | 25 | 25 | 24 | 50 | 40 |
| | B-2 | | | | | | | | |
| | B-3 | | | | | | | | |
| | B-4 | | 30 | | | | | | |
| (C) Fiber reinforcement | C-1 | 20 | 20 | 20 | 20 | 20 | 16 | 5 | 5 |
| (D) Plate-like hexagonal boron nitride powder | D-1 | | | 15 | 5 | | 3 | 4 | 5 |
| (E) Titanium oxide | E-1 | 1 | 1 | | 1 | 1 | 1 | 1 | 1 |
| Other additive agent | F-1 | | | | | | 10 | | |
| | F-2 | | | | | 5 | | | |
| | F-3 | | | | | 1 | | | |
| (G) Sheet mica | G-1 | | | | | | | | |
| Surface direction thermal diffusivity in 1.0 mm | mm²/sec | 0.90 | 1.00 | 1.35 | 0.85 | 0.85 | 0.75 | 1.45 | 1.30 |
| Thickness direction thermal diffusivity in 1.0 mm | mm²/sec | 0.45 | 0.50 | 0.85 | 0.45 | 0.40 | 0.35 | 0.65 | 0.62 |
| Thermal diffusivity anisotropy in 1.0 mm | Ratio | 2.0 | 2.0 | 2.1 | 1.9 | 2.1 | 2.1 | 2.2 | 2.1 |
| Surface direction thermal diffusivity in 2.0 mm | mm²/sec | 0.60 | 0.67 | 0.00 | 0.57 | 0.57 | 1.00 | 0.95 | 0.85 |
| Thickness direction thermal diffusivity in 2.0 mm | mm²/sec | 0.32 | 0.36 | 0.48 | 0.32 | 0.28 | 0.50 | 0.50 | 0.45 |
| Thermal diffusivity anisotropy in 2.0 mm | Ratio | 1.9 | 1.9 | 1.9 | 1.8 | 2.0 | 2.0 | 1.9 | 1.9 |
| Electric insulation property | Ω · cm | 10¹⁵ | 10¹⁵ | 10¹⁵ | 10¹⁵ | 10¹⁵ | 10¹⁵ | 10¹⁵ | 10¹⁵ |
| Whiteness | — | 84 | 82 | 82 | 84 | 83 | 83 | 81 | 82 |
| Melt flow rate | g/10 min | 60 | 60 | 30 | 55 | 110 | 100 | 35 | 40 |
| Izod impact strength | J/m | 35 | 33 | 40 | 36 | 33 | 33 | 23 | 25 |

| | Number/ | Comparative Example | | | | | | | |
|---|---|---|---|---|---|---|---|---|---|
| | Unit | 1 | 2 | 3 | 4 | 5 | 6 | 7 | 8 |
| (A) Thermoplastic polyester resin | A-1 | 100 | 49 | 49 | | 50 | 30 | 50 | 49 |
| Thermoplastic polyphenylene sulfide resin | A-2 | | | | 49 | | | | |
| (B) Platy talc particles | B-1 | | | | 30 | | 70 | 10 | |
| | B-2 | | 30 | | | | | | |
| | B-3 | | | 30 | | | | | |
| | B-4 | | | | | | | | |
| (C) Fiber reinforcement | C-1 | | 20 | 20 | 20 | 50 | | 40 | 20 |
| (D) Plate-like hexagonal boron nitride powder | D-1 | | | | | | | | |
| (E) Titanium oxide | E-1 | | 1 | 1 | 1 | | | 1 | 1 |
| Other additive agent | F-1 | | | | | | | | |
| | F-2 | | | | | | | | |
| | F-3 | | | | | | | | |
| (G) Sheet mica | G-1 | | | | | | | | 30 |
| Surface direction thermal diffusivity in 1.0 mm | mm²/sec | 0.09 | 0.45 | 0.50 | N/A | N/A | N/A | N/A | 0.70 |
| Thickness direction thermal diffusivity in 1.0 mm | mm²/sec | 0.08 | 0.35 | 0.40 | N/A | N/A | N/A | N/A | 0.35 |
| Thermal diffusivity anisotropy in 1.0 mm | Ratio | 1.1 | 1.3 | 1.3 | — | — | N/A | N/A | 2.0 |
| Surface direction thermal diffusivity in 2.0 mm | mm²/sec | 0.09 | 0.33 | 0.35 | N/A | N/A | N/A | N/A | 0.50 |
| Thickness direction thermal diffusivity in 2.0 mm | mm²/sec | 0.08 | 0.25 | 0.26 | N/A | N/A | N/A | N/A | 0.27 |
| Thermal diffusivity anisotropy in 2.0 mm | Ratio | 1.1 | 1.3 | 1.3 | — | — | N/A | N/A | 1.9 |
| Electric insulation property | Ω · cm | 10¹⁶ | 10¹⁵ | 10¹⁵ | N/A | N/A | N/A | N/A | 10¹⁵ |
| Whiteness | — | 65 | 80 | 80 | N/A | N/A | N/A | N/A | 67 |
| Melt flow rate | g/10 min | 120 | 60 | 55 | N/A | N/A | N/A | N/A | 50 |
| Izod impact strength | J/m | 100 | 30 | 30 | N/A | N/A | N/A | N/A | 30 |

Note)
Compounding ratios are all represented in % by volume.

As is clear from Table 1, the highly thermally conductive resin molded articles of Examples 1 through 8 have excellent molding flowability, whiteness, and impact strength, as compared with the highly thermally conductive resin molded articles of Comparative Examples 1 through 8. Moreover, the highly thermally conductive resin molded article of Comparative Example 8, in which the (G) sheet mica is used instead of the (B) platy talc particles, is inferior in surface direction thermal diffusivity in 1.0 mm and 2.0 mm and is significantly inferior in whiteness. Note that “N/A” in Table 1 indicates that a corresponding property could not be measured because a target article was difficult to prepare as a molded article.

### INDUSTRIAL APPLICABILITY

The highly thermally conductive resin molded article of the present invention is applicable to various uses such as an electronic material, a magnetic material, a catalytic material, a structural material, an optical material, a medical material, an automotive material, and an architectural material, in various forms such as a resin film form, a resin sheet form, and a resin molded article form. Moreover, the highly thermally conductive resin molded article of the present invention can be produced by the use of a general injection molding machine for plastic, which machine is widely used at present. Therefore, the highly thermally conductive resin molded article of the present invention can easily have a complicated shape. Further, the highly thermally conductive resin of the present invention has excellent characteristics, that is, both the molding processability and the high thermal conductivity, and is therefore highly suitable to be used as resin for housing of a device such as a mobile phone, a display, and a computer, each of which internally includes a heat source.

Moreover, the highly thermally conductive resin molded article of the present invention can be suitably used as an injection-molded article such as a household electrical appliance, office-automation equipment parts, audio and visual equipment parts, and interior and exterior parts of an automobile. In particular, the highly thermally conductive resin molded article of the present invention can be suitably used as an exterior material of a household electrical appliance, office-automation equipment, and the like which generate a large amount of heat.

Further, the highly thermally conductive resin molded article of the present invention can be suitably used as an exterior material of electronic equipment, which internally includes a heat source but is difficult to have a forced cooling mechanism such as a fan, so that heat generated inside the electronic equipment can be released to the outside. The highly thermally conductive resin molded article of the present invention is highly suitable to be used as a housing or an exterior material of a small or mobile electronic equipment such as a mobile computer such as a notebook computer; a personal digital assistant (PDA); a mobile phone; a portable game machine; a portable music player; a portable TV/video device; and a portable video camera. Moreover, the highly thermally conductive resin molded article of the present invention is highly suitable to be used as a material such as resin for a periphery of a battery of an automobile, an electric train, or the like; resin for a mobile battery of a household electrical appliance; resin for an electric distribution component such as a circuit breaker; and an encapsulant for a motor.

Note that the highly thermally conductive resin molded article of the present invention has better impact resistance and surface smoothness, as compared with a conventionally known resin molded article. Therefore, the highly thermally conductive resin molded article of the present invention is suitably used as a part or a housing in the above described applications.

1. A highly thermally conductive resin molded article at least comprising:
(A) thermoplastic polyester resin;
(B) platy talc particles; and
(C) a fiber reinforcement,
(B) platy talc particle content falling within a range between 10% by volume and 60% by volume, where an entire composition is 100% by volume,
a number average particle size of the (B) platy talc particles falling within a range between 20 μm and 80 μm, and
the (B) platy talc particles being oriented in a surface direction of said highly thermally conductive resin molded article.

2. The highly thermally conductive resin molded article as set forth in claim 1, wherein:
said highly thermally conductive resin molded article has been molded by an injection molding method.

3. The highly thermally conductive resin molded article as set forth in claim 1, wherein:
a volume ratio of the (B) platy talc particles is higher than that of the (C) fiber reinforcement.

4. The highly thermally conductive resin molded article as set forth in claim 1, wherein:
a melt flow rate falls within a range between 5 g/10 min and 200 g/10 min under a condition that a temperature is 280° C. and a load is 100 kgf.

5. The highly thermally conductive resin molded article as set forth in claim 1, wherein:
a tap density of the (B) platy talc particles is 0.60 g/ml or higher.

6. The highly thermally conductive resin molded article as set forth in claim 1, wherein:
an aspect ratio of a cross section of the (B) platy talc particles falls within a range between 5 and 30.

7. A highly thermally conductive resin molded article as set forth in claim 1, further comprising:
(D) plate-like hexagonal boron nitride powder,
(D) plate-like hexagonal boron nitride powder content falling within a range between 1% by volume and 40% by volume, where the entire composition is 100% by volume, and
a number average particle size of the (D) plate-like hexagonal boron nitride powder being 15 μm or larger.

8. A highly thermally conductive resin molded article as set forth in claim 1, further comprising:
(E) titanium oxide,
(E) titanium oxide content falling within a range between 0.1% by volume and 5% by volume, where the entire composition is 100% by volume, and
a number average particle size of the (E) titanium oxide being 5 μm or smaller.

9. The highly thermally conductive resin molded article as set forth in claim 1, wherein:
whiteness of said highly thermally conductive resin molded article is 80 or higher.

10. The highly thermally conductive resin molded article as set forth in claim 1, wherein:
(A) thermoplastic polyester resin content falls within a range between 35% by volume and 55% by volume, where the entire composition is 100% by volume.

11. The highly thermally conductive resin molded article as set forth in claim 1, wherein:
(C) fiber reinforcement content falls within a range between 5% by volume and 35% by volume, where the entire composition is 100% by volume.

12. The highly thermally conductive resin molded article as set forth in claim 1, wherein:
a surface direction thermal diffusivity, which is a thermal diffusivity in the surface direction of said highly thermally conductive resin molded article, is at least 1.6 times as high as a thickness direction thermal diffusivity which is a thermal diffusivity in a thickness direction that is perpendicular to the surface direction; and
the surface direction thermal diffusivity is 0.5 mm²/sec or higher.

13. The highly thermally conductive resin molded article as set forth in claim 1, wherein:
a surface direction thermal diffusivity, which is a thermal diffusivity in the surface direction of said highly thermally conductive resin molded article, is at least 1.7 times as high as a thickness direction thermal diffusivity which is a thermal diffusivity in a thickness direction that is perpendicular to the surface direction; and
the surface direction thermal diffusivity is 0.5 mm²/sec or higher.

14. The highly thermally conductive resin molded article as set forth in claim 1, wherein:
a volume resistivity value of said highly thermally conductive resin molded article is 10¹⁰ Ω·cm or greater.

15. A method for manufacturing a highly thermally conductive resin molded article recited in claim 2, said method comprising the step of:
carrying out injection molding,
in the step of carrying out injection molding, the (B) platy talc particles being oriented in the surface direction of the highly thermally conductive resin molded article.
